(19) United States
(12) Patent Application Publication
(10) Pub. No.: US 2023/0137030 A1
(43) Pub. Date: May 4, 2023

(54) PUNCHING BLADE, PUNCHING UNIT, IMAGE FORMING APPARATUS, AND FINISHING DEVICE

(71) Applicant: KYOCERA Document Solutions Inc., Osaka-shi, Osaka (JP)

(72) Inventor: Rina Okada, Osaka (JP)

(21) Appl. No.: 17/913,132

(22) PCT Filed: Mar. 24, 2021
(86) PCT No.: PCT/JP2021/012160

§ 371 Date: Sep. 20, 2022

(30) Foreign Application Priority Data
May 8, 2020 (JP) 2020-082497

(51) Int. Cl. B26F 1/14; B65H 35/06

(52) U.S. Cl. CPC B26F 1/14; B65H 35/06

(57) ABSTRACT

An object of the present invention is to reduce loads during a punching process and to reduce punching time. A punching blade is provided with a blade edge portion including multiple peaks and multiple valleys formed alternately in a circumferential direction. A blade edge line of the blade edge portion has first areas corresponding to the valleys, second areas extending from the peaks to the valleys, and third areas connecting the first areas and the second areas. In a side view of the blade edge portion, the first areas form curved lines along first arcs having a center point on a punching axis, the second areas form curved lines along second arcs having center points located in areas between the punching axis and the highest points of the peaks, and the third areas form straight lines along common tangents to the first arcs and the second arcs.

### TECHNICAL FIELD

The present invention relates to a punching blade for punching holes in sheets, a punching unit provided with the punching blade, an image forming apparatus, and a finishing device.

### BACKGROUND ART

A punching unit is known to perform a punching process of punching holes in sheets before the sheets are discharged to a sheet discharge tray after image formation. Such a punching unit is provided with punching blades extending along punching axes and moving mechanisms that reciprocate the punching blades along the punching axes, and reciprocates the punching blades to punch holes in sheets.

PTLs 1 and 2 disclose techniques for reducing loads generated when the punching unit punches holes in sheets. In the techniques, a blade edge portion of each punching blade includes alternately formed edge peaks and edge valleys, and the blade edge line of the blade edge portion has a shape capable of reducing loads generated when the edge peaks penetrate a sheet and reducing loads generated when the edge valleys cut through the sheet.

### CITATION LIST

### Patent Literature

[PTL 1] Japanese Patent Application Publication No. 2011-148040

[PTL 2] Japanese Patent Application Publication No. 2012-56040

### SUMMARY OF THE INVENTION

### Problems to be Solved by the Invention

However, in the known techniques, no consideration for the shape of the blade edge line of the blade edge portion in the punching blade is given to the length between the edge peaks and the edge valleys along the punching axis. The length between the edge peaks and the edge valleys along the punching axis correlates with punching time required by the punching blade to punch a hole in a sheet.

An object of the present invention is to provide a punching blade, a punching unit, an image forming apparatus, and a finishing device capable of reducing loads in a punching process of punching holes in sheets and, furthermore, capable of reducing punching time.

### Solution to the Problems

A punching blade according to an aspect of the present invention is included in a punching unit. The punching blade is configured to be inserted into a die hole in a die member along a punching axis and punch a binding hole in a sheet together with a hole edge of the die hole. The punching blade is provided with a body portion and a blade edge portion. The body portion has a cylindrical shape extending along the punching axis. The blade edge portion is formed at one end of the body portion and has a waveform including a plurality of peaks and a plurality of valleys formed alternately in a circumferential direction. A blade edge line that forms an edge end of the blade edge portion has first areas corresponding to the valleys, second areas corresponding to the peaks, and third areas connecting the first areas and the second areas. In a case where highest points of the peaks that face each other are located at both ends in a side view of the blade edge portion, lowest points of the valleys are located in a middle, the first areas form curved lines along first arcs having a center point on the punching axis and passing through the lowest points of the valleys, the second areas form curved lines along second arcs having center points located in areas between the punching axis and the highest points of the peaks, and the third areas form straight lines along common tangents to the first arcs and the second arcs.

In addition, an image forming apparatus according to another aspect of the present invention is provided with an image forming portion configured to perform an image formation process of forming an image on a sheet and the punching unit configured to punch a hole in a sheet that has undergone the image formation process.

In addition, a finishing device according to another aspect of the present invention is disposed adjacent to an image forming apparatus configured to form an image on a sheet. The finishing device is provided with a carry-in port configured to receive a sheet discharged from the image forming apparatus, the punching unit configured to punch a hole in the sheet, a carry-out port configured to discharge the sheet, and a discharge tray on which the sheet discharged from the carry-out port can be stacked.

### Advantageous Effects of the Invention

The present invention can provide the punching blade, the punching unit, and the image forming apparatus capable of reducing loads in the punching process of punching holes in sheets and, furthermore, capable of reducing punching time.

### BRIEF DESCRIPTION OF THE DRAWINGS

FIG. 1 is a cross-sectional view schematically showing an internal configuration of an image forming apparatus provided with a main image forming portion and a finishing device including a punching unit equipped with punching blades according to an embodiment of the present invention.

FIG. 2 is a perspective view of the punching unit.

FIG. 3 is a front view of a punching portion of the punching unit and shows a punching blade in a raised state.

FIG. 4 is a front view of the punching portion of the punching unit and shows the punching blade in a lowered state.

FIG. 5 is a perspective view of the punching blade.

FIG. 6 is a diagram showing the shape of a blade edge portion of the punching blade, in which FIG. 6A is a plan view of the blade edge portion viewed from below and FIG. 6B is a net showing the shape of the edge end of the blade edge portion.

FIG. 7 is an enlarged view of the blade edge portion of the punching blade.

### DESCRIPTION OF EMBODIMENTS

The following describes a punching blade according to an embodiment of the present invention, a punching unit provided with the punching blade, and an image forming apparatus with reference to the drawings.

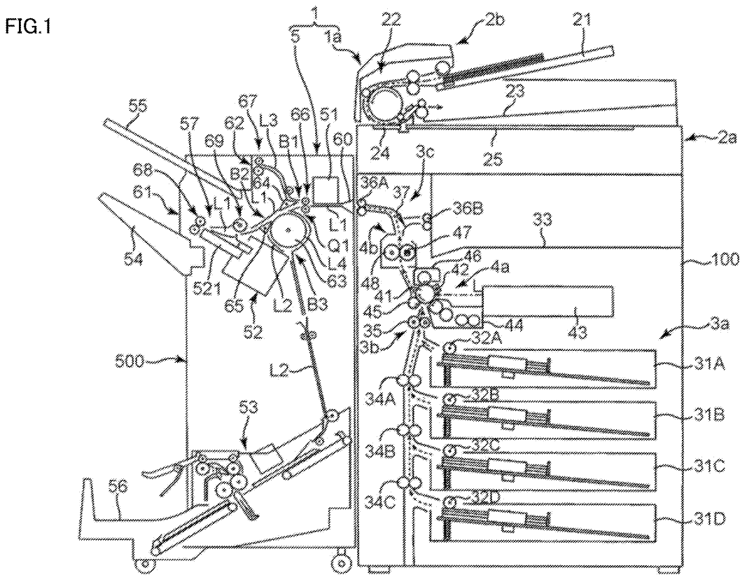

FIG. 1 is a cross-sectional view schematically showing an internal configuration of an image forming apparatus 1. The image forming apparatus 1 is provided with a main image forming portion 1a and a finishing device 5 including a punching unit 51 equipped with punching blades according to an embodiment of the present invention. The main image forming portion 1a shown in FIG. 1 is a monochrome copier of a so-called “in-body discharge type”. However, the main image forming portion 1a may be a color copier, printer, a facsimile apparatus, or a multifunction peripheral equipped with those functions.

The image forming apparatus 1 includes the main image forming portion 1a and the finishing device 5. The main image forming portion 1a performs an image formation process on sheets. The finishing device 5 is provided with a finishing portion that performs predetermined finishing processes on sheets or sheet stacks each including multiple sheets that have undergone the image formation process, and is disposed adjacent to the main image forming portion 1a. The finishing processes include a punching process of punching binding holes in sheets, a stapling process of inserting staples into sheet stacks, a folding process of folding sheets, and an alignment process of shifting sheets, aligning the widthwise edges of sheets, and the like.

The main image forming portion 1a is provided with a main portion housing 100, an image reading portion 2a disposed in an upper part of the main portion housing 100, and an automatic document feeder (ADF) 2b disposed on the upper surface of the image reading portion 2a. The main portion housing 100 houses a sheet feed portion 3a, a conveyance path 3b, an image forming portion 4a, a fixing portion 4b, and a sheet discharge portion 3c.

The automatic document feeder 2b automatically feeds document sheets to be duplicated to a predetermined first document sheet reading position. The first document sheet reading position corresponds to a position at which a first contact glass 24 is assembled in the image reading portion 2a. In a case where document sheets are placed on a predetermined second document sheet reading position, the automatic document feeder 2b is lifted up from the upper surface of the image reading portion 2a. The second document sheet reading position corresponds to a position at which the second contact glass 25 is disposed in the image reading portion 2a. The automatic document feeder 2b includes a document sheet tray 21 on which document sheets are placed, a document sheet conveying portion 22 that conveys the document sheets through the first document sheet reading position, and a document sheet discharge tray 23 to which the read document sheets are discharged.

The image reading portion 2a includes a box-shaped housing, and the first contact glass 24 and the second contact glass 25 are fitted in the upper surface of the image reading portion 2a. The first contact glass 24 is used to read images on the document sheets automatically fed from the automatic document feeder 2b. The second contact glass 25 is used to read images on the manually placed document sheets. The image reading portion 2a optically reads the images on the document sheets.

The sheet feed portion 3a inside the main portion housing 100 includes multiple cassettes 31 (31A, 31B, 31C, and 31D). The cassettes 31 are respectively provided with sheet feed rollers 32 (32A, 32B, 32C, and 32D) that are rotationally driven. The sheet feed rollers 32 feed sheets to the conveyance path 3b one by one during the image formation process.

The conveyance path 3b is disposed inside the main portion housing 100. The sheets are conveyed from the sheet feed portion 3a to an in-body discharge tray 33 or to the finishing device 5 along the conveyance path 3b. The conveyance path 3b is provided with guide plates for guiding the sheets, pairs of conveying rollers 34 (34A, 34B, and 34C), and a pair of registration rollers 35. The pairs of conveying rollers 34 are rotationally driven while the sheets are being conveyed. The pair of registration rollers 35 keeps the sheets that are being conveyed at a position before the image forming portion 4a and feeds the sheets in synchronization with transfer of formed toner images.

The image forming portion 4a creates toner images and transfers the toner images onto the sheets. That is, the image forming portion 4a forms images on the sheets. The image forming portion 4a includes a photoconductor drum 41 and other components including a charging unit 42, an exposure unit 43, a developing device 44, a transfer roller 45, and a cleaning device 46 disposed around the photoconductor drum 41.

The photoconductor drum 41 includes a peripheral surface on which electrostatic latent images and toner images are formed as the photoconductor drum 41 rotates around its axis. The charging unit 42 uniformly charges the surface of the photoconductor drum 41.

The exposure unit 43 includes a laser source and optical instruments such as mirrors and lenses. The exposure unit 43 emits a laser beam L based on image data about the images on the document sheets onto the peripheral surface of the photoconductor drum 41 to form the electrostatic latent images. The developing device 44 supplies toner to the peripheral surface of the photoconductor drum 41 to develop the electrostatic latent images formed on the photoconductor drum 41. The transfer roller 45 forms a transfer nip portion between itself and the photoconductor drum 41 and receives a transfer bias. The toner images on the photoconductor drum 41 are transferred to the sheets passing through the transfer nip portion. The cleaning device 46 includes a cleaning roller and the like to clean the peripheral surface of the photoconductor drum 41 after the toner images are transferred.

The fixing portion 4b fixes the toner images transferred to the sheets. The fixing portion 4b includes a heating roller 47 with a built-in heating element and a pressure roller 48 in pressure contact with the heating roller 47. The sheets with the toner images transferred thereto pass through a fixing nip formed by the heating roller 47 and the pressure roller 48. This heats and fuses the toner to fix the toner images to the sheets. The sheets after the fixing process are sent to the sheet discharge portion 3c.

The sheet discharge portion 3c includes a pair of outward discharge rollers 36A and a pair of inward discharge rollers 36B. The pair of outward discharge rollers 36A feeds the sheets after the image formation to the finishing device 5. The pair of inward discharge rollers 36B feeds the sheets after the image formation to the in-body discharge tray 33. The pairs of discharge rollers 36A and 36B are rotationally driven during a discharge operation to discharge the sheets to the exterior of the apparatus. In addition, the sheet discharge portion 3c includes a switch lever 37 that switches the conveying direction of the sheets.

The finishing device 5 includes a finishing device housing 500 disposed adjacent to the main portion housing 100 and the finishing portion disposed inside the finishing device housing 500. In the present embodiment, the finishing portion is provided with the punching unit 51, a stapling unit 52, a folding unit 53, and an alignment portion 57. The punching unit 51, the stapling unit 52, and the alignment portion 57 are housed in an upper part of the finishing device housing 500. The folding unit 53 is housed in a lower part of the finishing device housing 500.

The finishing device housing 500 has a carry-in port 60 in a side face facing the main portion housing 100. The sheets after the image formation process are taken into the finishing device housing 500 through the carry-in port 60. The finishing device housing 500 has a main carry-out port 61 and a sub carry-out port 62 in a side face remote from the main portion housing 100. The sheets are discharged from the finishing device housing 500 through these carry-out ports. A main discharge tray 54 corresponding to the main carry-out port 61 and a sub discharge tray 55 corresponding to the sub carry-out port 62 are attached to the finishing device housing 500. In addition, the finishing device housing 500 is provided therein with a first conveyance route L1, a second conveyance route L2, a third conveyance route L3, a fourth conveyance route L4, a first merge point Q1, a first branch point B1, a second branch point B2, a third branch point B3, and a turnout drum 63.

The first conveyance route L1 is used to convey the sheets delivered through the carry-in port 60 to the main carry-out port 61. The sheets discharged from the main carry-out port 61 is discharged to the main discharge tray 54.

The third conveyance route L3 branches off from the first conveyance route L1 at the first branch point B1. The third conveyance route L3 extends from the first branch point B1 to the sub carry-out port 62. The sheets discharged from the sub carry-out port 62 is discharged to the sub discharge tray 55.

The second conveyance route L2 branches off from the first conveyance route L1 at the second branch point B2. The second conveyance route L2 extends from the second branch point B2 to the folding unit 53. The fourth conveyance route L4 branches off from the second conveyance route L2 at the third branch point B3, curves along the perimeter of the turnout drum 63, and merges with the first conveyance route L1 at the first merge point Q1.

A first switch blade 64 is disposed at the first branch point B1. The first switch blade 64 keeps the sheets conveyed on the first conveyance route L1 on the same first conveyance route L1 or switches the destination of the sheets to the third conveyance route L3. A second switch blade 65 is disposed at the second branch point B2. The second switch blade 65 switches the destination of the sheets between the first conveyance route L1 and the second conveyance route L2.

A pair of first conveying rollers 66 is disposed upstream of the first branch point B1. In addition, a pair of fourth conveying rollers 68 is disposed at the downstream end of the first conveyance route L1 and adjacent to the main carry-out port 61. Furthermore, a pair of second conveying rollers 69 is disposed on the first conveyance route L1 upstream of the pair of fourth conveying rollers 68. The sheets passing through the first conveyance route L1 are conveyed from the carry-in port 60 to the main discharge tray 54 through the main carry-out port 61 by the pair of first conveying rollers 66, the pair of second conveying rollers 69, and the pair of fourth conveying rollers 68.

A pair of third conveying rollers 67 is disposed at the downstream end of the third conveyance route L3 and adjacent to the sub carry-out port 62. The sheets conveyed on the third conveyance route L3 are discharged to the sub discharge tray 55 by the pair of third conveying rollers 67.

The punching unit 51 is disposed adjacent to the entrance of the first conveyance route L1. The punching unit 51 performs the punching process of punching binding holes on sheets at predetermined timings. The punching unit 51 punches the holes in the sheets at positions adjacent to the trailing edges in the conveying direction of the sheets. During the punching process, the sheets are temporarily stopped. The details of the punching unit 51 will be described later.

The stapling unit 52 performs the stapling process of inserting staples into sheet stacks each including multiple sheets. The stapling process here is a process for so-called edge binding in which the staples are inserted into the corners or edges of the sheet stacks. In a case where the stapling process is performed, the sheets are conveyed to a position adjacent to the main carry-out port 61 along the first conveyance route L1 and then delivered onto a staple tray 521 while a conveyance nip portion of the pair of fourth conveying rollers 68 is released. Thus, the sheets are stacked on the staple tray 521. The sheet stacks that have undergone the stapling process are taken out from the staple tray 521 to the main discharge tray 54 by the pair of fourth conveying rollers 68 of which the conveyance nip portion is recovered.

The folding unit 53 performs the folding process of folding the sheet stacks into two in the midsection in addition to middle binding of inserting staples into the midsection of the sheet stacks. The sheets that undergo the folding process are guided from the first conveyance route L1 to the second conveyance route L2 via the second branch point B2 and delivered to the folding unit 53. The sheet stacks that have undergone the folding process are discharged to a folded sheet discharge tray 56 disposed in the lower part of the finishing device housing 500. It is noted that the folding unit 53 may perform only the folding process.

The alignment portion 57 performs the shifting operation or the alignment process. The shifting operation is an operation to shift sheets or sheet stacks in a sheet width direction orthogonal to the conveying direction of the sheets. The alignment process includes the edge alignment operation to align the widthwise edges of the sheet stacks. When the stapling unit 52 performs the stapling process, the alignment portion 57 performs the shifting operation or the edge alignment operation on the sheet stacks to set stapling positions. In addition, the alignment portion 57 may also operate without the stapling process. For example, the alignment portion 57 also operates in a case where the sheets are stacked on the main discharge tray 54 while undergoing offset discharge. The offset discharge is an operation to stack, for example, multiple sets of copies created from one group of multiple document sheets on the main discharge tray 54 while shifting the sets of the copies from one another in the sheet width direction.

The sheets or sheet stacks that have undergone the stapling process, the shifting operation, or the edge alignment operation are discharged from the main carry-out port 61 by the pair of fourth conveying rollers 68 and stacked on the main discharge tray 54. The main discharge tray 54 gradually moves downward from the uppermost position as the discharged sheet stacks increase. Subsequently, after the sheet stacks are removed from the main discharge tray 54, the main discharge tray 54 moves upward to return to the standard position. The sub discharge tray 55 receives the sheets discharged from the sub carry-out port 62 by the pair of third conveying rollers 67. The sheets discharged without any specific finishing process by the finishing device 5 or the sheets that have undergone only the punching process are mainly stacked on the sub discharge tray 55.

The turnout drum 63 has a peripheral surface and is rotationally driven in a predetermined rotation direction. In a case where multiple sheet stacks are successively stapled, the turnout drum 63 allows the first page of a sheet stack to be wrapped around the surface of the turnout drum 63 to wait for the stapling unit 52 to staple the previous sheet stack. The function of the turnout drum 63 eliminates the need for temporary halt of the delivery of the sheets from the main image forming portion 1a during the stapling process, thereby increasing the productivity.

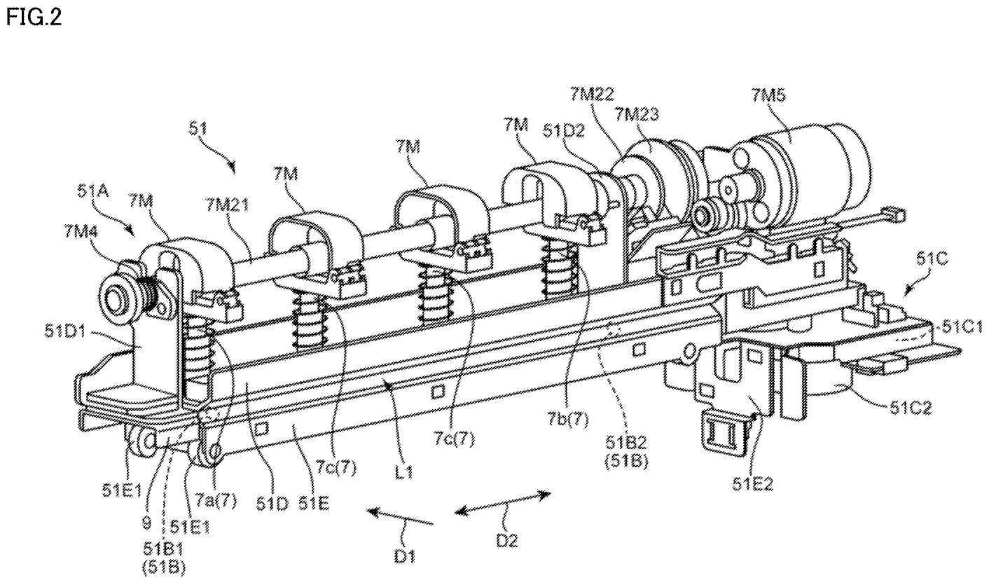

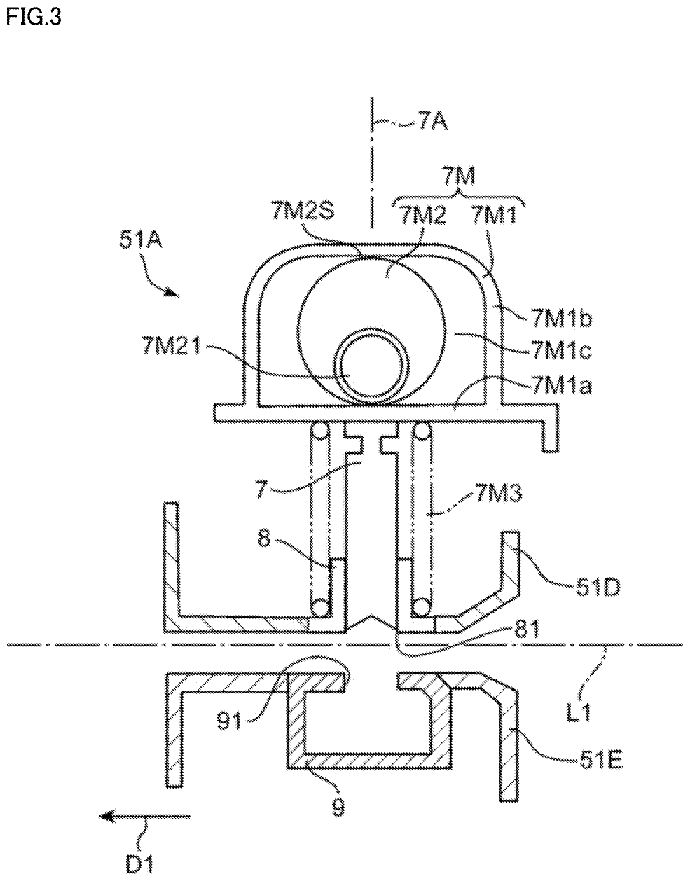

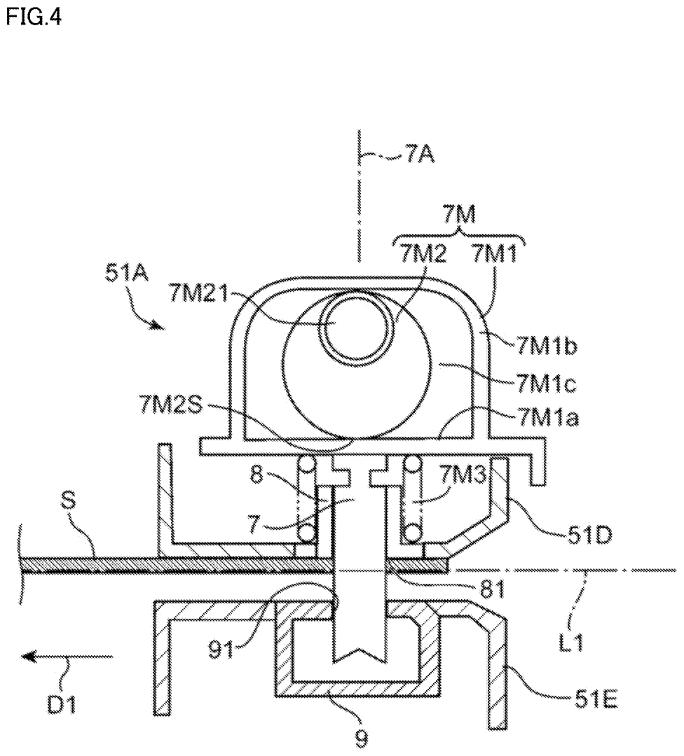

Next, the punching unit 51 according to the present embodiment will be described in detail with reference to FIGS. 2 to 4 in addition to FIG. 1. FIG. 2 is a perspective view of the punching unit 51. In addition, FIGS. 3 and 4 are front views of a punching portion 51A of the punching unit 51. FIG. 3 shows a punching blade 7 in a raised state, and FIG. 4 shows the punching blade 7 in a lowered state.

A sheet S delivered to the finishing device 5 through the carry-in port 60 is conveyed on the first conveyance route L1 to reach the punching unit 51. The punching unit 51 includes the punching portion 51A, detection portions 51B, and a shifter 51C. The punching portion 51A performs the punching process of punching binding holes in the sheet S conveyed on the first conveyance route L1. The detection portions 51 B detect the positions of both side edges of the sheet S in a sheet width direction D2 orthogonal to a conveying direction D1 of the sheet S. The shifter 51C shifts the punching portion 51A and the detection portions 51B in the sheet width direction D2. The punching portion 51A and the detection portions 51B are shiftable in the sheet width direction D2 on a rail portion (not shown) provided for the finishing device housing 500.

The punching portion 51A is provided with the four punching blades 7, raising and lowering mechanisms 7M (moving mechanisms), guide members 8, and a die member 9. The four punching blades 7 are disposed at predetermined intervals in the sheet width direction D2. The raising and lowering mechanisms 7M reciprocate (raise and lower) the respective punching blades 7 along punching axes 7A. The guide members 8 guide the ascending and descending of the respective punching blades 7. The punching blades 7, the raising and lowering mechanisms 7M, and the guide members 8 are supported by an upper guide frame 51D. The die member 9 is supported by a lower guide frame 51E to face the guide members 8 with the first conveyance route L1 in between.

The upper guide frame 51D is a frame member having a substantially U-shaped cross-section with an open top and extending in the sheet width direction D2. The lower guide frame 51E is a frame member extending in the sheet width direction D2. The lower guide frame 51E has a substantially U-shaped cross-section with an open bottom. The lower guide frame 51E is provided with rollers 51E1 in a lower end part near either end in the sheet width direction D2. The rollers 51E1 can travel on the rail portion of the finishing device housing 500 in the sheet width direction D2.

The punching blades 7 include a punching blade 7a disposed on one side in the sheet width direction D2, a punching blade 7b on another side in the sheet width direction D2, and two punching blades 7c disposed between the punching blade 7a and the punching blade 7c. The punching blades 7 have a cylindrical shape extending in the respective punching axes 7A. The distance between the punching axis 7A of the punching blade 7a and the punching axis 7A of the punching blade 7b is equal to the width of the sheet S. The details of the punching blades 7 will be described later.

Each of the guide members 8 has a cylindrical shape with a circular guide hole 81 through which the corresponding punching blade 7 can be placed. The guide member 8 guides the ascending and descending of the punching blade 7 placed through the guide hole 81. The punching blade 7 is driven to ascend and descend along the punching axis 7A by the corresponding raising and lowering mechanism 7M (described later). The guide members 8 are provided for the respective punching blades 7. Each of the guide members 8 is positioned on the upper guide frame 51D such that the center of the guide hole 81 is located on the corresponding punching axis 7A.

The die member 9 is a rectangular tube member extending in the sheet width direction D2. The die member 9 faces the guide members 8 with the first conveyance route L1 in between. The die member 9 is shared among all the punching blades 7. In the upper surface of the die member 9, circular die holes 91 that allow the blade edge portions of the punching blades 7 to be fitted therein are formed to correspond to the respective punching blades 7. The die member 9 is secured to the lower guide frame 51E such that the center of each die hole 91 is located on the punching axis 7A of the corresponding punching blade 7.

The blade edge portions of the punching blades 7 descending as being guided to the guide holes 81 of the guide members 8 are inserted into the die holes 91 of the die member 9. At this moment, the punching blades 7 and the hole edges of the die holes 91 punch binding holes in the sheet S conveyed on the first conveyance route L1.

The raising and lowering mechanisms 7M are mechanisms that raise and lower the respective punching blades 7 along the punching axes 7A. The raising and lowering mechanisms 7M are provided for the respective punching blades 7. Each of the raising and lowering mechanisms 7M includes a support member 7M1 that supports the corresponding punching blade 7 and a cam 7M2 that engages with the support member 7M1. The support member 7M1 is composed of a flat portion 7M1a extending in the sheet conveying direction D1 and a curved portion 7M1b formed by bending a thin, flat piece into a substantially semicircular shape. The punching blade 7 is secured to the lower surface of the flat portion 7M1a in the vicinity of the middle in the sheet conveying direction D1 to be substantially vertical. Both ends of the curved portion 7M1b are supported on the upper surface of the flat portion 7M1a at both ends in the sheet conveying direction D1. A hollow portion 7M1c having a substantially semicircular shape when viewed from front is formed between the flat portion 7M1a and the curved portion 7M1b of the support member 7M1.

A coil spring 7M3 is placed between the support member 7M1 and the upper guide frame 51D around the outer perimeter of the guide member 8. The coil spring 7M3 biases the support member 7M1 upward.

The cam 7M2 of each raising and lowering mechanism 7M has a flattened cylindrical shape and is supported by a rotation shaft 7M21 at a position eccentric to the axis center. The rotation shaft 7M21 passes through the hollow portions 7M1c of the support members 7M1. The ends of the rotation shaft 7M21 in the sheet width direction D2 are rotatably supported by a first side plate portion 51D1 and a second side plate portion 51D2. The first side plate portion 51D1 and the second side plate portion 51D2 extend upward from the upper surface of the upper guide frame 51D at the respective ends in the sheet width direction D2.

In addition, a coil spring 7M4 is placed between the first side plate portion 51D1 and one end of the rotation shaft 7M21 in the sheet width direction D2. The coil spring 7M4 biases the rotation shaft 7M21 to the one side in the sheet width direction D2. The rotation shaft 7M21 is movable in the axial direction by a solenoid (not shown). The rotation shaft 7M21 selectively engages the cams 7M2 with the support members 7M1 in the two raising and lowering mechanisms 7M in the middle and in the two raising and lowering mechanisms 7M at both ends in the sheet width direction D2. That is, when the cams 7M2 engage with the support members 7M1 in the two raising and lowering mechanisms 7M at both ends, the cams 7M2 disengage from the support members 7M1 in the two raising and lowering mechanisms 7M in the middle. This allows the two punching blades 7a and 7b at both ends in the sheet width direction D2 to ascend and descend. On the other hand, when the cams 7M2 engage with the support members 7M1 in the two raising and lowering mechanisms 7M in the middle, the cams 7M2 disengage from the support members 7M1 in the two raising and lowering mechanisms 7M at both ends. This allows the two punching blades 7c in the middle in the sheet width direction D2 to ascend and descend. As described above, in a normal condition, the rotation shaft 7M21 is biased by the coil spring 7M4 to the one side in the sheet width direction D2. This causes the cams 7M2 to engage with the support members 7M1 in the two raising and lowering mechanisms 7M at both ends, allowing the two punching blades 7a and 7b at both ends in the sheet width direction D2 to ascend and descend. When the solenoid is switched, the rotation shaft 7M21 moves to the other side in the sheet width direction D2 against the biasing force of the coil spring 7M4, and the cams 7M2 engage with the support members 7M1 in the two raising and lowering mechanisms 7M in the middle. This allows the two punching blades 7c in the middle to ascend and descend.

Another end of the rotation shaft 7M4 in the sheet width direction is connected to the rotation shaft of a motor 7M5 with a gear train in between. When the motor 7M5 drives the rotation shaft 7M4, the cams 7M2 rotate inside the hollow portions 7M1c of the support members 7M1. At this moment, when cam surfaces 7M2S of the cams 7M2 engage with the inner surfaces of the curved portions 7M1b of the support members 7M1, the punching blades 7 are kept in the raised state (see FIG. 3). In addition, when the cam surfaces 7M2S of the cams 7M2 engage with the upper surfaces of the flat portions 7M1a of the support members 7M1, the support members 7M1 are pushed downward against the biasing force of the coil springs 7M3 (see FIG. 4). Thus, the punching blades 7 vertically descend as being guided by the guide holes 81 of the guide members 8, and the blade edge portions of the punching blades 7 protruding toward the first conveyance route L1 punch binding holes in the sheet S between the die holes 91 of the die member 9 and themselves.

In addition, a sensor 7M22 for detecting the home position, a rotary encoder 7M23 for controlling the rotational speed of the rotation shaft 7M21, and the like are disposed at the other end of the rotation shaft 7M21 in the sheet width direction D2.

As shown in FIG. 2, the detection portions 51B include a first detection portion 51B1 and a second detection portion 51B2. The first detection portion 51B1 is disposed on the one side in the sheet width direction D2 and upstream in the sheet conveying direction D1 relative to the punching blade 7a. The second detection portion 51B2 is disposed on the other side in the sheet width direction D2 and upstream in the sheet conveying direction D1 relative to the punching blade 7b.

For example, optical sensors may be adopted as the detection portions 51B. Each of the optical sensors includes a light emitting portion and a light receiving portion facing each other. Either the light emitting portions or the light receiving portions are secured to the upper guide frame 51D, and the others are secured to the lower guide frame 51E. That is, the detection portions 51B are integral to the punching portion 51A. When the sheet S lies between the light emitting portions and the corresponding light receiving portions, the optical paths of light emitted from the light emitting portions are blocked, and the amounts of light received by the light receiving portions change. The detection portions 51B detect the side edges of the sheet S in the sheet width direction D2 based on the change in the amounts of light.

The shifter 51C is disposed on the other side in the sheet width direction D2 relative to the punching portion 51A. The shifter 51C includes a drive mechanism 51C1 composed of a rack and pinion gear and a motor 51C2 that rotates the pinion gear. The rack is disposed on the lower surface of the lower guide frame 51E to extend in the sheet width direction D2. The pinion gear is connected to the rotation shaft of the motor 51C2, and the motor 51C2 is attached to a support plate 51E2. When the pinion gear is rotated by the motor 51C2, the punching portion 51A and the detection portions 51B reciprocate with the rack meshing with the pinion gear. At this moment, the punching portion 51A and the detection portions 51B reciprocate in the sheet width direction D2 between a first punching position and a second punching position with the standard position in the middle.

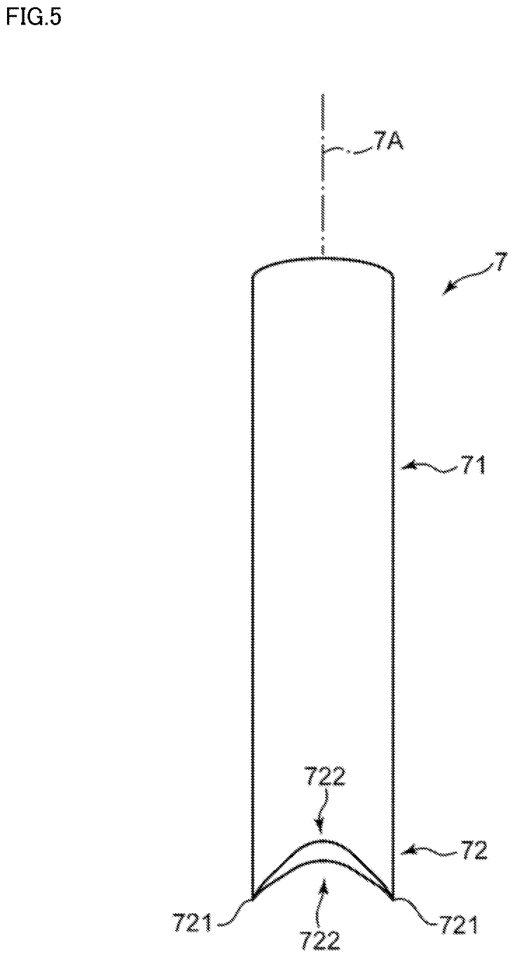

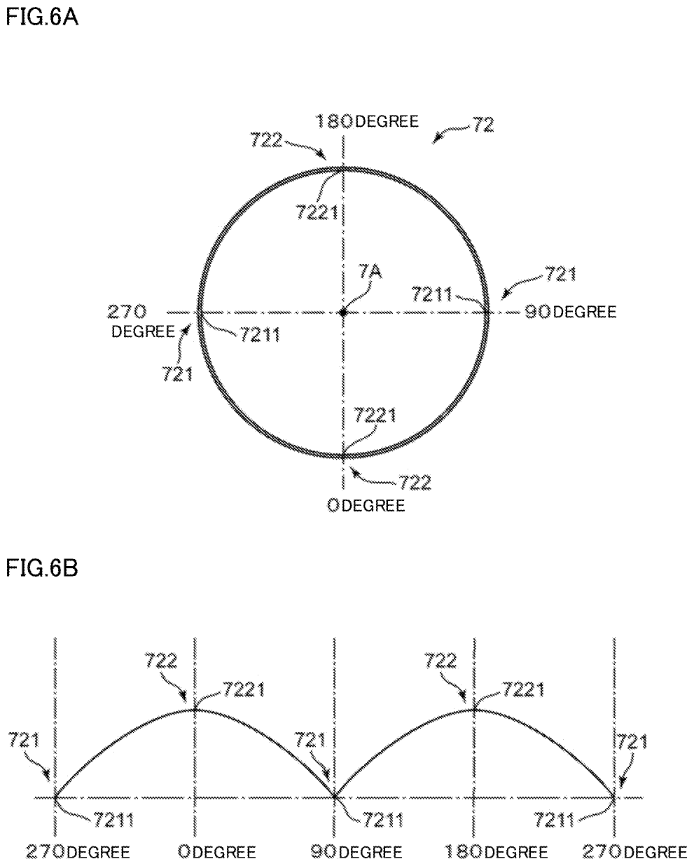

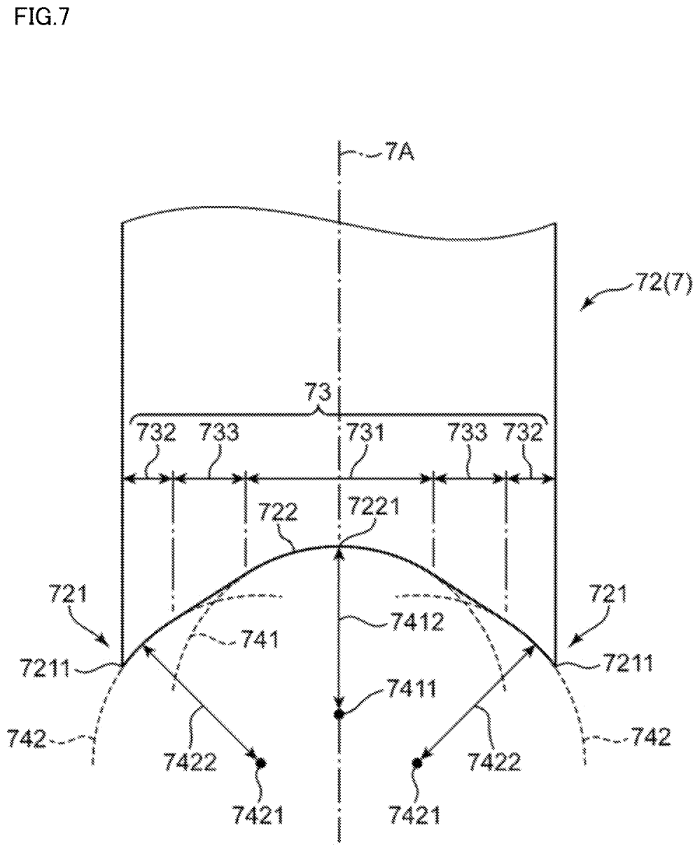

Next, the punching blades 7 will be described in detail with reference to FIGS. 5 to 7 in addition to FIGS. 3 and 4. FIG. 5 is a perspective view of one of the punching blades 7. FIG. 6 is a diagram showing the shape of a blade edge portion 72 of the punching blade 7. FIG. 7 is an enlarged view of the blade edge portion 72 of the punching blade 7. It is noted that FIG. 6A is a plan view of the blade edge portion 72 viewed from below and that FIG. 6B is a net showing the shape of the edge end of the blade edge portion 72.

The punching blade 7 is provided with a body portion 71 and the blade edge portion 72 formed at one end of the body portion 71. The body portion 71 has a cylindrical shape extending along the punching axis 7A. The blade edge portion 72 includes multiple peaks 721 and multiple valleys 722 formed alternately in the circumferential direction. The body portion 71 and the blade edge portion 72 are integral to each other, and the punching blade 7 as a whole has a cylindrical shape extending along the punching axis 7A serving as the central axis passing through the center of the punching blade 7. In the present embodiment, as shown in FIGS. 5 and 6A, the blade edge portion 72 includes two peaks 721 facing each other and two valleys 722 facing each other. In the blade edge portion 72 having the above-described configuration, the peaks 721 and the valleys 722 are alternately arranged every 90 degrees in the circumferential direction. That is, as the net in FIG. 6B shows, the edge end of the blade edge portion 72 has a waveform having, in a case where the lowest point 7221 of one of the valleys 722 is located at 0 degrees in the circumferential direction, the highest point 7211 of one of the peaks 721 located at 90 degrees, the lowest point 7221 of the other valley 722 located at 180 degrees, and the highest point 7211 of the other peak 721 located at 270 degrees.

In the blade edge portion 72, the peaks 721 protrude the most to one side (downward) in the axial direction of the punching axis 7A. The peaks 721 serve as the starting point of the punching process in which the punching blade 7 punches a binding hole in the sheet S. The peaks 721 penetrate the sheet S during the punching process by the punching blade 7. In the blade edge portion 72, the valleys 722 are recessed the most to another side (upward) in the axial direction of the punching axis 7A. The valleys 722 serve as the ending point of the punching process by the punching blade 7. The valleys 722 cut through the sheet S during the punching process by the punching blade 7.

The edge end of the blade edge portion 72 forms a blade edge line 73 having first areas 731, second areas 732, and third areas 733. The first areas 731 are areas corresponding to the valleys 722. The second areas 732 extend from the peaks 721 to the valleys 722. The second areas 732 are areas corresponding to the peaks 721. The third areas 733 connect the first areas 731 and the second areas 732. As shown in FIG. 7 in which the blade edge portion 72 is viewed from the side, in a case where the highest points 7211 of the two peaks 721 facing each other are located at both ends, the lowest points 7221 of the two valleys 722 are located in the middle. The first areas 731 form curved lines along first arcs 741 having a center point 7411 on the punching axis 7A and passing through the lowest points 7221 of the valleys 722. The second areas 732 form curved lines along second arcs 742 having center points 7421 located in areas between the punching axis 7A and the highest points 7211 of the peaks 721 in the second areas 732. The third areas 733 form straight lines along common tangents to the first arcs 741 and the second arcs 742.

When the punching blade 7 provided with the blade edge portion 72 having the above-described configuration punches a binding hole in the sheet S, the peaks 721 penetrate the sheet S first, the curved parts in the second areas 732 and the straight parts in the third areas 733 in the blade edge line 73 of the blade edge portion 72 tear the sheet S, and then the entire faces of the valleys 722 including the curved parts in the first areas 731 cut through the sheet S. Here, the punching blade 7 provided with the blade edge portion 72 having the above-described configuration is compared with an inverted V-shaped blade. The inverted V-shaped blade is a punching blade having an inverted V-shaped blade edge line when viewed from the side. It is noted that the length of sections between the peaks 721 and the valleys 722 in the blade edge portion 72 having the above-described configuration in a direction along the punching axis 7A is assumed to be equal to the length of sections between the peaks and the valleys in the inverted V-shaped blade in the direction along the punching axis 7A. In this case, the peaks 721 of the blade edge portion 72 having the above-described configuration are sharper than the peaks in the inverted V-shaped blade and have higher penetrability into the sheet S. In addition, the valleys 722 of the blade edge portion 72 are gently curved compared with the valleys in the inverted V-shaped blade, and thereby the entire faces of the valleys 722 demonstrate higher performance in cutting through the sheet S. Accordingly, in the punching blade 7 provided with the blade edge portion 72 having the above-described configuration, the blade edge portion 72 can punch a binding hole in the sheet S smoothly along the blade edge line 73 between when the peaks 721 penetrate the sheet S and when the valleys 722 cut through the sheet S. As a result, loads in the punching process by the punching blade 7 can be reduced. Furthermore, loads on the motor 7M5 in the raising and lowering mechanisms 7M that reciprocate the punching blades 7 can be reduced. Accordingly, noise such as operating noise and vibrating noise generated as the motor 7M5 is driven can be eliminated or minimized. In addition, small motors can be adopted as the motor 7M5, leading to a reduction in the size of the punching unit 51.

In addition, the center points 7421 of the second arcs 742 formed by the second areas 732 extending from the peaks 721 to the valleys 722 in the blade edge line 73 of the blade edge portion 72 are not on the punching axis 7A, that is, off the punching axis 7A. On the other hand, in a known technique, the centers of arcs corresponding to the peaks 721 are on the punching axis 7A. In a case where the punching blade 7 is adopted, the length of the sections between the peaks 721 and the valleys 722 in the direction along the punching axis 7A can be reduced compared with a case where the known technique is adopted. As a result, time for the punching process by the punching blade 7 can be reduced.

Furthermore, in the side view of the blade edge portion 72 in the punching blade 7 of the present embodiment, in the case where the highest points 7211 of the two peaks 721 facing each other are located at both ends, the lowest points 7221 of the two valleys 722 are located in the middle, and the blade edge line 73 is symmetric about the punching axis 7A. In this case, when the punching blade 7 punches a binding hole in the sheet S, regions on the blade edge line 73 brought into contact with the sheet S are symmetric about the punching axis 7A in the side view of the blade edge portion 72. Thus, the blade edge portion 72 can cut through the sheet S along the blade edge line 73 evenly in directions orthogonal to the punching axis 7A. As a result, a binding hole can be smoothly punched in the sheet S.

Furthermore, in the punching blade 7 of the present embodiment, the center point 7411 of the first arcs 741 is closer to the lowest points 7221 of the valleys 722 than the center points 7421 of the second arcs 742 in the direction along the punching axis 7A, and the radius 7412 of the first arcs 741 is smaller than the radius 7422 of the second arcs 742. This improves the performance of the valleys 722 in cutting through the sheet S.

1. A punching blade in a punching unit configured to be inserted into a die hole in a die member along a punching axis and punch a binding hole in a sheet together with a hole edge of the die hole, the punching blade comprising:
a body portion having a cylindrical shape extending along the punching axis; and
a blade edge portion formed at one end of the body portion and having a waveform including a plurality of peaks and a plurality of valleys formed alternately in a circumferential direction, wherein
a blade edge line that forms an edge end of the blade edge portion has first areas corresponding to the valleys, second areas corresponding to the peaks and third areas connecting the first areas and the second areas, and
in a case where highest points of the peaks that face each other are located at both ends in a side view of the blade edge portion, lowest points of the valleys are located in a middle,
the first areas form curved lines along first arcs having a center point on the punching axis and passing through the lowest points of the valleys,
the second areas form curved lines along second arcs having center points located in areas between the punching axis and the highest points of the peaks, and
the third areas form straight lines along common tangents to the first arcs and the second arcs.

2. The punching blade according to claim 1, wherein
the blade edge line is symmetric about the punching axis in the side view of the blade edge portion.

3. The punching blade according to claim 1, wherein
the center point of the first arcs is closer to the lowest points of the valleys than the center points of the second arcs in a direction along the punching axis, and
the first arcs have a smaller radius than the second arcs.

4. A punching unit comprising:
the punching blade according to claim 1; and
a moving mechanism configured to reciprocate the punching blade along the punching axis.

5. An image forming apparatus comprising:
an image forming portion configured to perform an image formation process of forming an image on a sheet; and
the punching unit according to claim 4 configured to punch a hole in a sheet that has undergone the image formation process.

6. A finishing device disposed adjacent to an image forming apparatus configured to form an image on a sheet, the finishing device comprising:
a carry-in port configured to receive a sheet discharged from the image forming apparatus;
the punching unit according to claim 4 configured to punch a hole in the sheet;
a carry-out port configured to discharge the sheet; and
a discharge tray on which the sheet discharged from the carry-out port can be stacked.
